(19) United States
(12) Patent Application Publication
(10) Pub. No.: US 2012/0096991 A1
(43) Pub. Date: Apr. 26, 2012

(54) Dual-drive, self-ratcheting mechanism

(76) Inventor: Leon R. Palmer, Somerset, MA (US)

(21) Appl. No.: 12/925,542

(22) Filed: Oct. 25, 2010

(51) Int. Cl. B25B 13/46

(52) U.S. Cl. 81/60

(57) ABSTRACT

A dual-drive self-ratcheting device, that eliminates the unproductive ratcheting-up motion between each productive drive, by employing a plurality of ratcheting or clutching mechanisms arranged in tandem, on a common drive shaft, that are caused to alternately drive the shaft continuously in one direction, as oscillatory motion is applied to its input.

While the first ratcheting/clutching mechanism is caused to impart motion onto a drive-shaft, the second ratcheting/clutching mechanism is simultaneously caused to override the driveshaft.

While the second ratcheting/clutching mechanism is caused to impart motion onto a drive-shaft, the first ratcheting/clutching mechanism is simultaneously caused to override the driveshaft.

### FIELD OF THE INVENTION

This invention relates to mechanical drive systems and more particularly to those in which the output rotation can be clockwise, regardless of the direction of the input rotation and the output rotation can be counterclockwise, regardless of the direction of the input rotation. The direction of output rotation, from an oscillatory input, is selective within the same embodiment.

### BACKGROUND OF THE INVENTION

This invention, a self-ratcheting mechanism, has numerous applications in consumer, medical and industrial products, but, a screwdriver is the preferred item to serve as the exemplification of the advantages, that the self-ratcheting mechanism provides. Prior art ratcheting screwdrivers, employ a single ratcheting mechanism, that is required to be intermittently-ratcheted between drives and therefore only ready-to-drive hardware 50% of the time, while the remaining 50%, is time and effort that is unproductively spent, ratcheting-up. Thus, screwdrivers, mechanized with the conventional single-ratcheting mechanism, are only 50% efficient.

Whereas, a screwdriver, mechanized with the self-ratcheting system, employs a pair of conventional ratcheting/clutching mechanisms to eliminate the user's need to waste time and effort ratcheting between drives. The ratcheting occurs automatically within the mechanism, as reciprocating input-motion is applied while the screwdriver is being operated.

Because the self-ratcheting concept comprises a minimum of a pair of any ratcheting or clutching means, solely for exemplification, all included illustrations depict a pair of the standard ratchet and pawl arrangement, with a 3-position switch for selecting forward-drive, reverse-drive and standard [non-ratcheting] direct-drive.

### BRIEF SUMMARY OF THE INVENTION

One objective of this invention, is to create a manually-operated, screwdriver hand tool, that ratchets-up automatically during use, thereby eliminating the user's need to perform the unproductive ratcheting-up motion between each productive drive.

Another objective, is to create a manually-operated, self-ratcheting screwdriver hand tool, that is operated single-handedly, thereby enabling fastening hardware, to be held in place with opposite hand.

Another objective is to provide a manually-operated self-ratcheting screwdriver hand tool, whereby resistance-to-backwards-rotation, from the screw during its installation into a material, to enable ratcheting-up, is no longer necessary.

Another objective is to provide a manually-operated, self-ratcheting screwdriver hand tool, with a mechanical means to simultaneously switch the pair of ratcheting mechanisms, from clockwise rotational output, to counterclockwise rotational output, and from counterclockwise rotational output to clockwise rotational output, to eliminate the switching of each ratchet mechanism separately. FIG. 6, 7, 8, 9

Another objective is to create a manually-operated, self-ratcheting screwdriver, whereby the self-ratcheting mechanism is operated via the axial turning of a pistol-grip-angled handle, in clockwise and clockwise direction, as well as swung radially, for added leverage for applying finishing-torque and breaking the finishing to torque loosen fastening hardware. FIG. 10, 11, 12, 13

Another objective is to create a manually-operated, self-ratcheting screwdriver hand tool, whereby its pistol-grip handle can be pivoted down further to perpendicular to the screwdriver body, thereby increasing torque capacity for tightening or loosening hardware. FIG. 14

Another objective is to create a manually-operated, self-ratcheting screwdriver hand tool, whereby its handle can be pivoted 360 degrees radially, relative to the screwdriver body, thereby enabling left-handed and right-handed operation, to drive hardware at a plurality of angles FIG. 15, FIG. 16

Another objective is to create a manually-operated, self-ratcheting screwdriver hand tool, whereby its handle can be radially pivoted to and retained in a plurality of desired angles, FIG. 5A, depending on the task and situation, such as limited space in which to maneuver the tool and difficult-to-access hardware.

Another objective is to create a manually-operated, self-ratcheting screwdriver hand tool, whereby, resistance-to-rotation from the hardware, is not required, in order for the ratcheting mechanism to ratchet-up.

### DESCRIPTION OF THE DRAWINGS

The preferred order-of-assembly of components of a self-ratcheting mechanism, that employs a pair of the standard ratchet and pawl arrangement is described below.

FIG. 1: Toothed Ratchet Wheel 16, prior to being slid onto and secured to Shaft 17, with Spring-Pin 21.

FIG. 2: Toothed Ratchet Wheel 16 is slid onto shaft 17. The thru-hole, that runs perpendicularly through the axis of Toothed Ratchet Wheel 16, is aligned with the thru-hole that runs perpendicular to the axis of Shaft 17. Spring-Pin 21 is pressed completely into both thru-holes to secure Toothed Ratchet Wheel 16 in place on Shaft 17.

FIG. 3, 10: Hub of Gear 9 is pressed completely into opening provided at posterior end of hollow Ratchet Housing 10. Subassembly Ratchet Housing 10/Gear 9 is slid onto Drive Shaft 17 until Housing 10 butts against Toothed Ratchet Wheel 16. Pawl 19 and Pawl 13 are placed into their respective recesses in Ratchet Housing 10 with their finger-like extensions engaging the teeth of toothed ratchet wheel 16. FIG. 3 Spring-loaded Switch 35, is placed onto Pawls 19 and 13 with its button facing up; Spring-loaded Switch 35 is compressed against Pawls 13 and 19 while Sleeve 40 is slid onto Housing 10 with Button projecting up through slot provided in Sleeve 40.

FIG. 4, 10: Axle 6 is inserted fully into center hole of Gear 5; free-end of Axle 6 is inserted into circular opening provided at the bottom recess in Gear-Train Housing 20; Housing 20 with Axle 6 and Gear 5 are slid onto shaft 17 until Gear-Train Housing 20 butts against Ratchet Housing 10. Gear-Train Housing 20 is symmetrical and can be slid onto Shaft 17 with either end first. Cover 42 is slid onto and secured to Gear-Train Housing 20 with Threaded Fastener 43.

FIG. 5, 10: Hub of Gear 7 is pressed completely into opening provided at anterior end of hollow Ratchet Housing 8. Gear 7/Ratchet Housing 8 subassembly, is slid onto Shaft 17 until Ratchet Housing 8 butts against Gear-Train Housing 20.

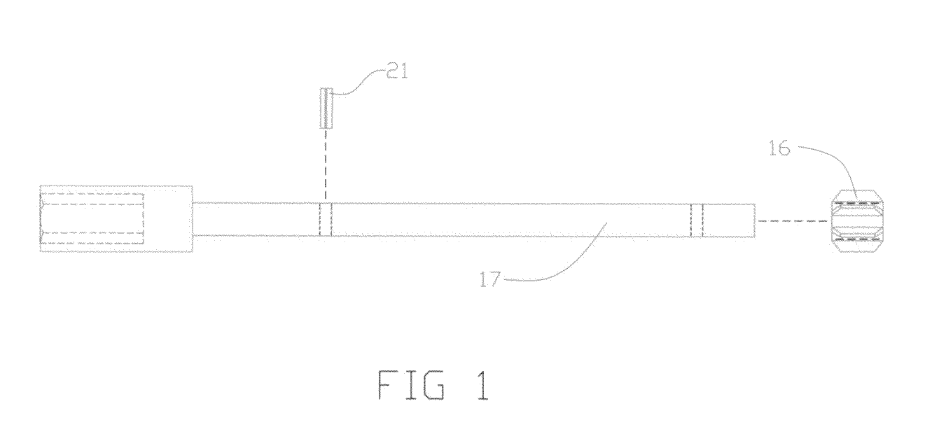

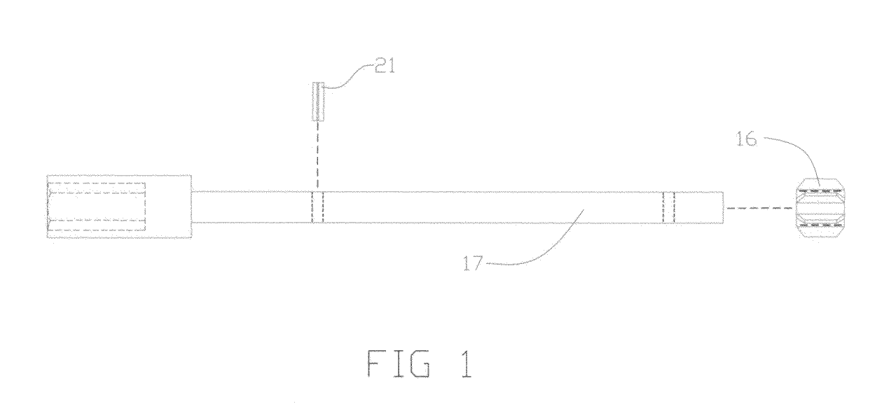

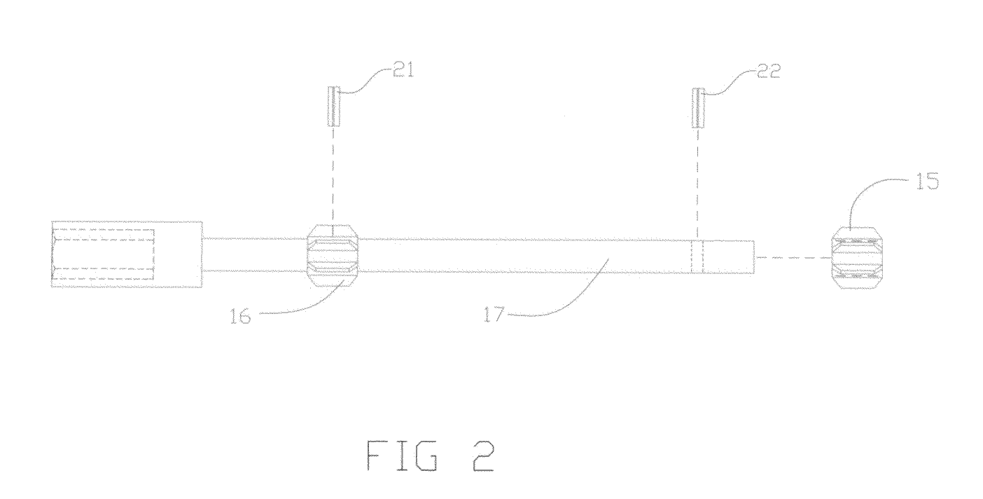

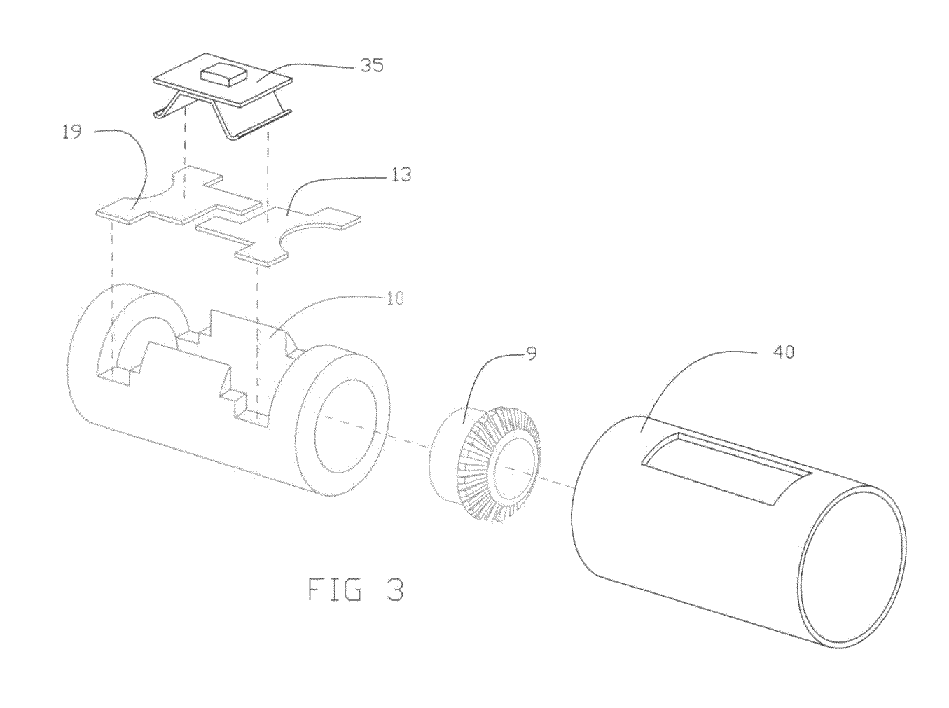

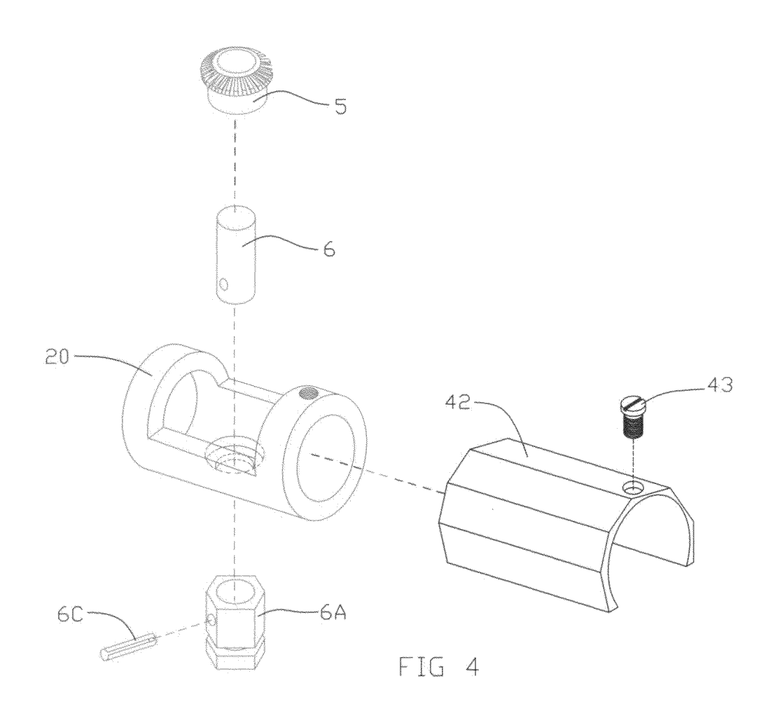

FIG. 2, 10: Toothed Ratchet Wheel 15 is slid onto Shaft 17, through opening at posterior of Ratchet Housing 8 and is secured to Shaft 17 with Spring-Pin 22. The thru-hole, that runs perpendicularly through the axis of Toothed Ratchet Wheel 15, is aligned with the thru-hole that runs perpendicular to the axis of Shaft 17. Spring-Pin 22 is pressed completely into both thru-holes to secure Toothed Ratchet Wheel 15 in place on Shaft 17.

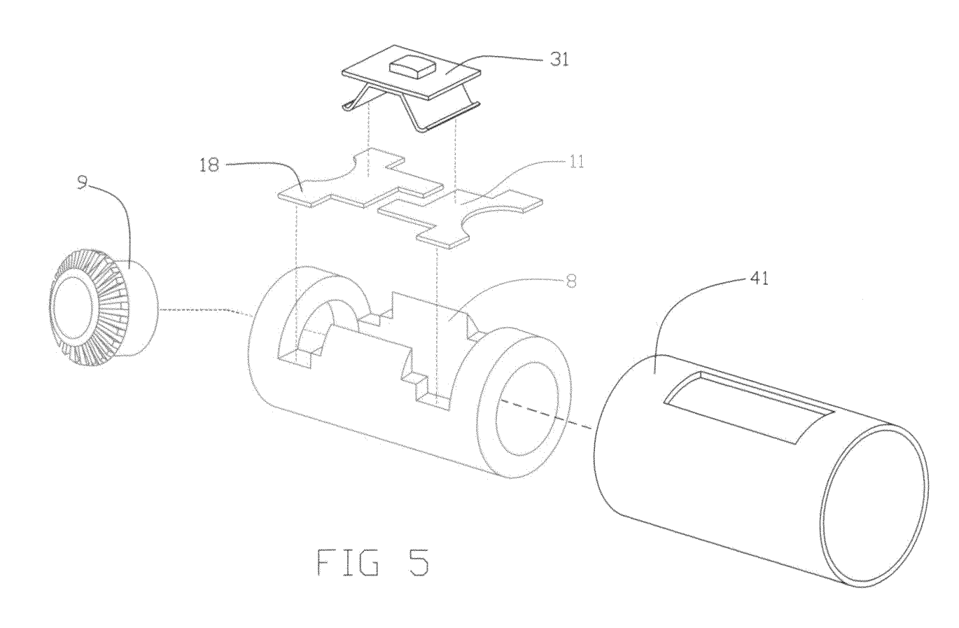

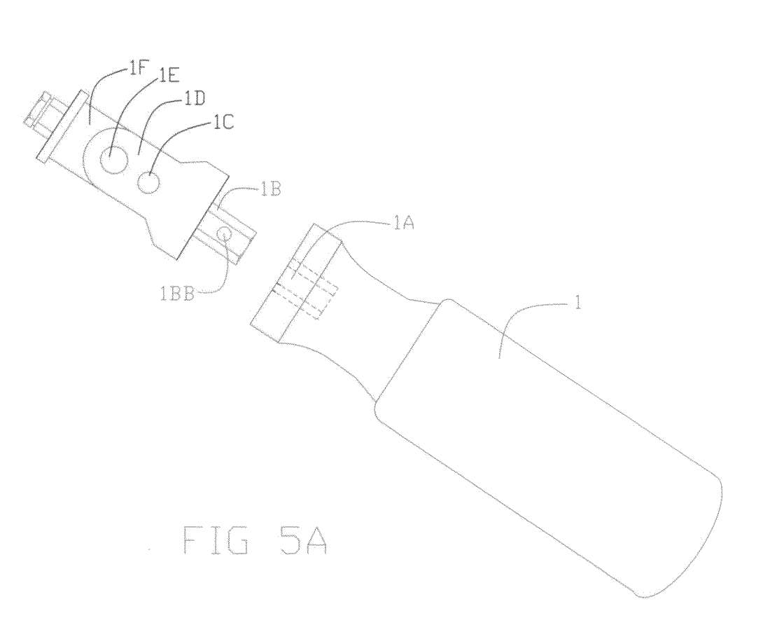

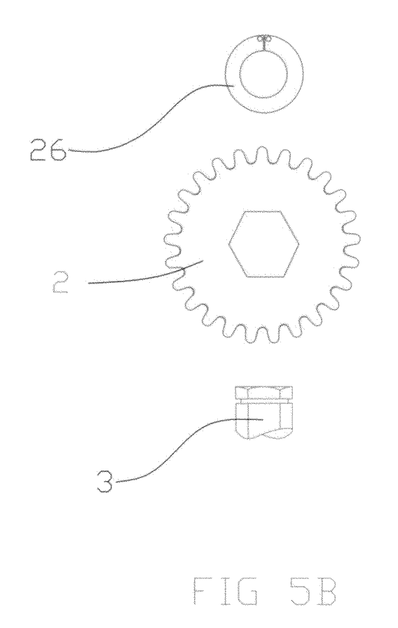

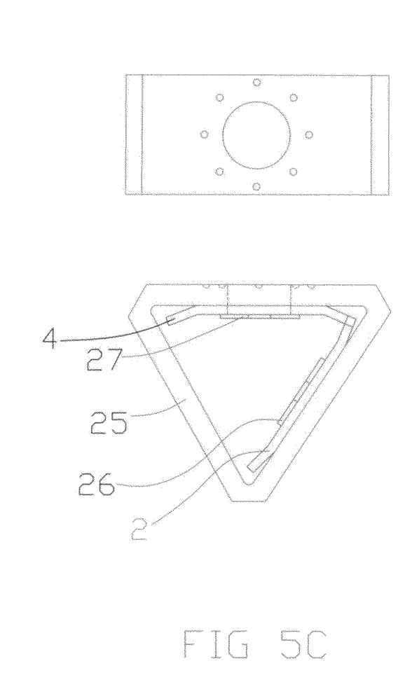

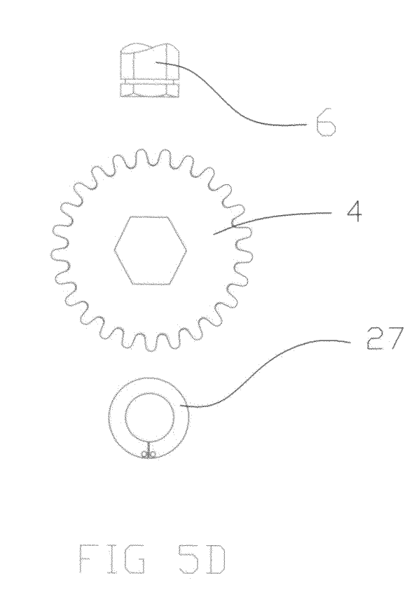

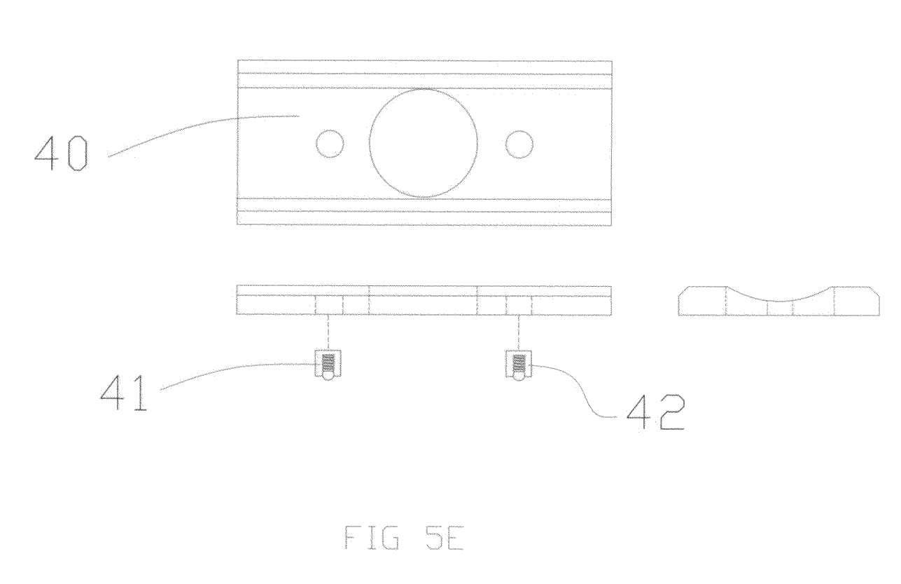

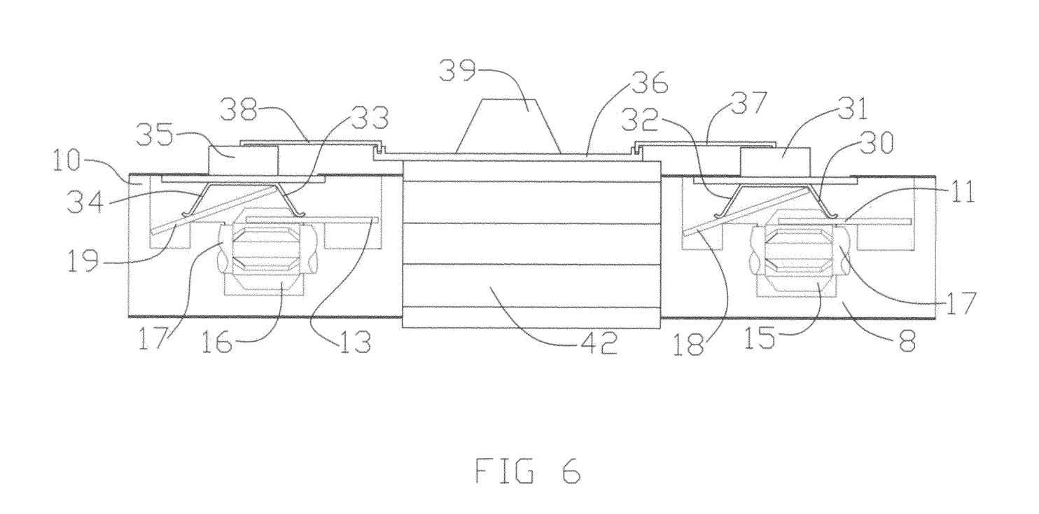

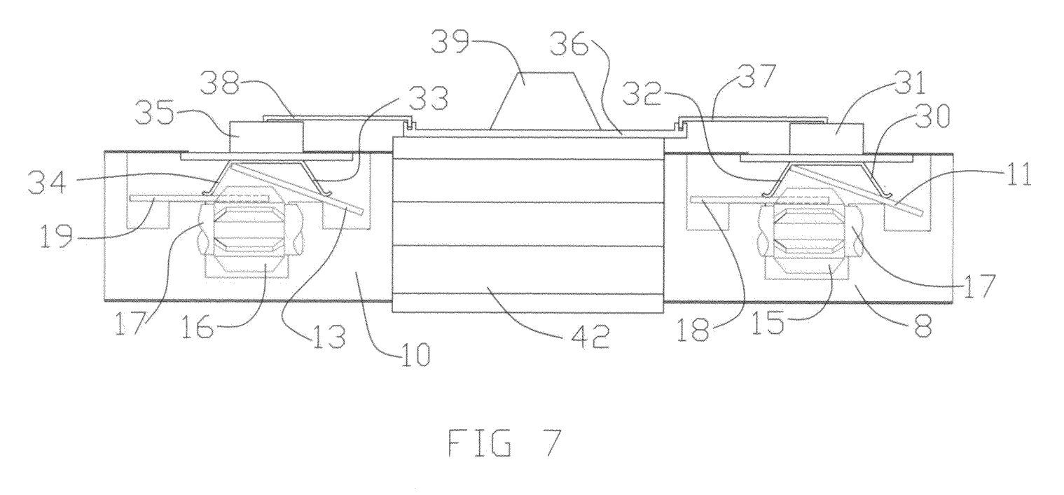

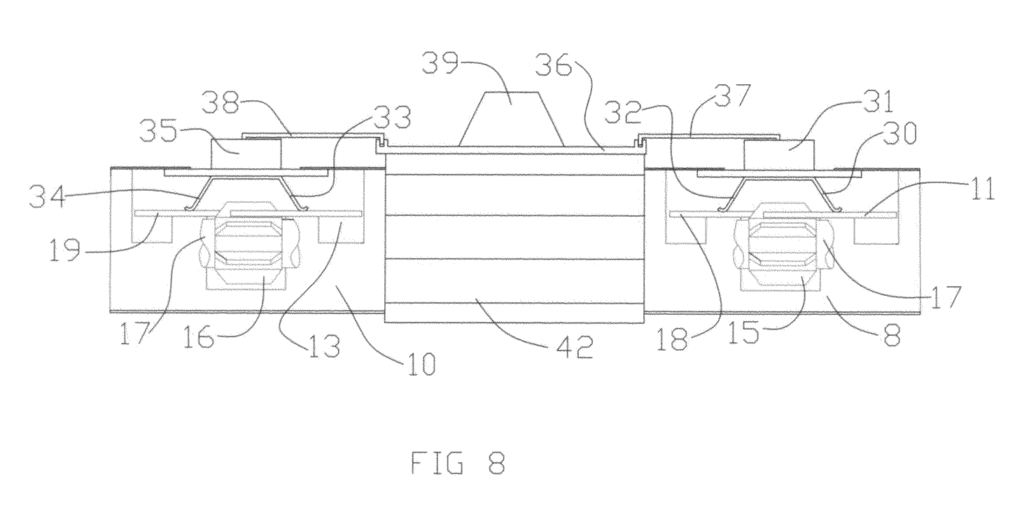

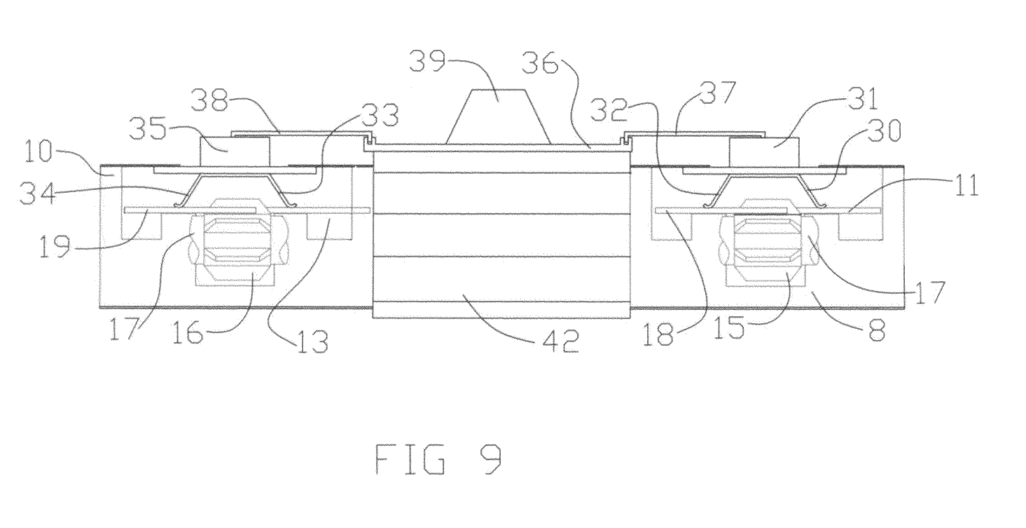

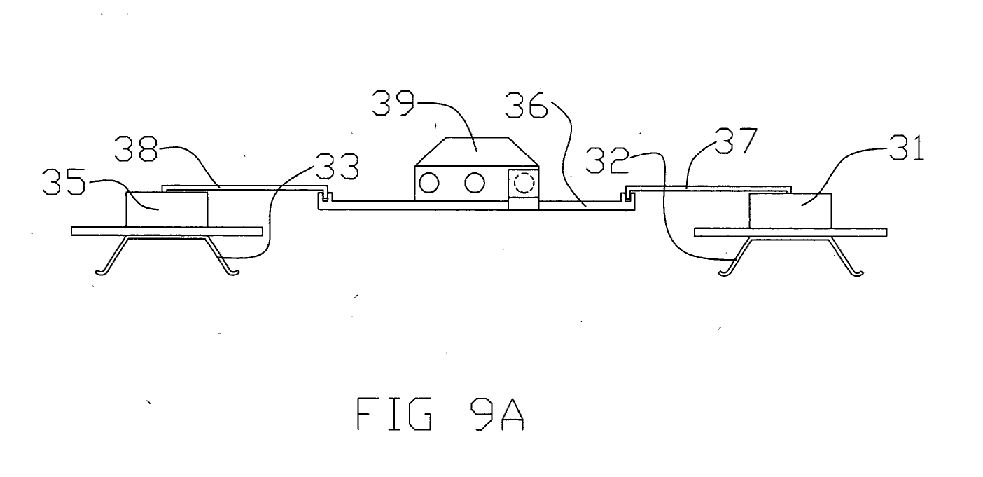

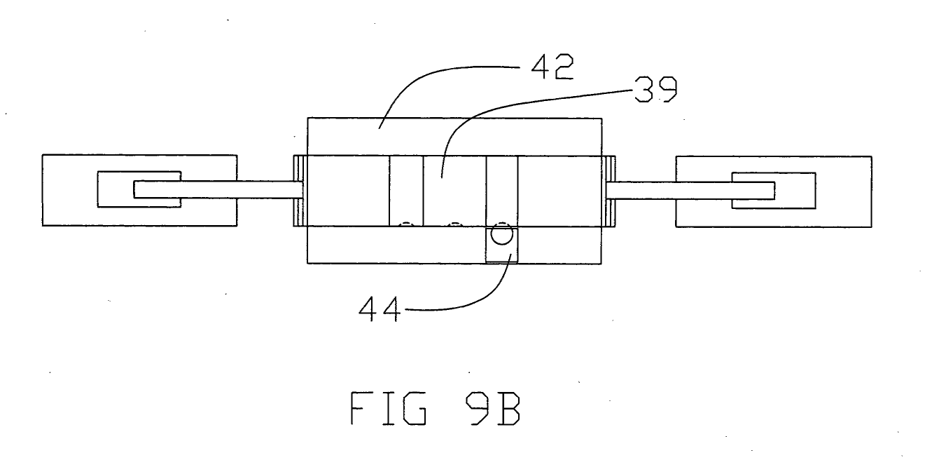

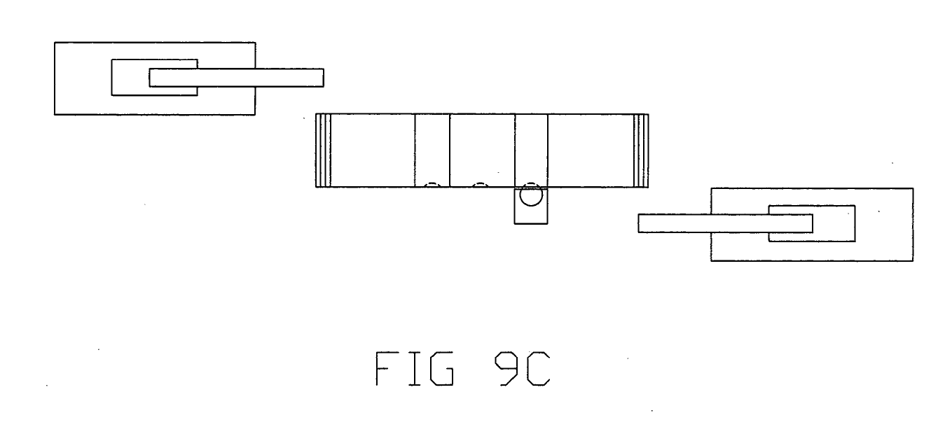

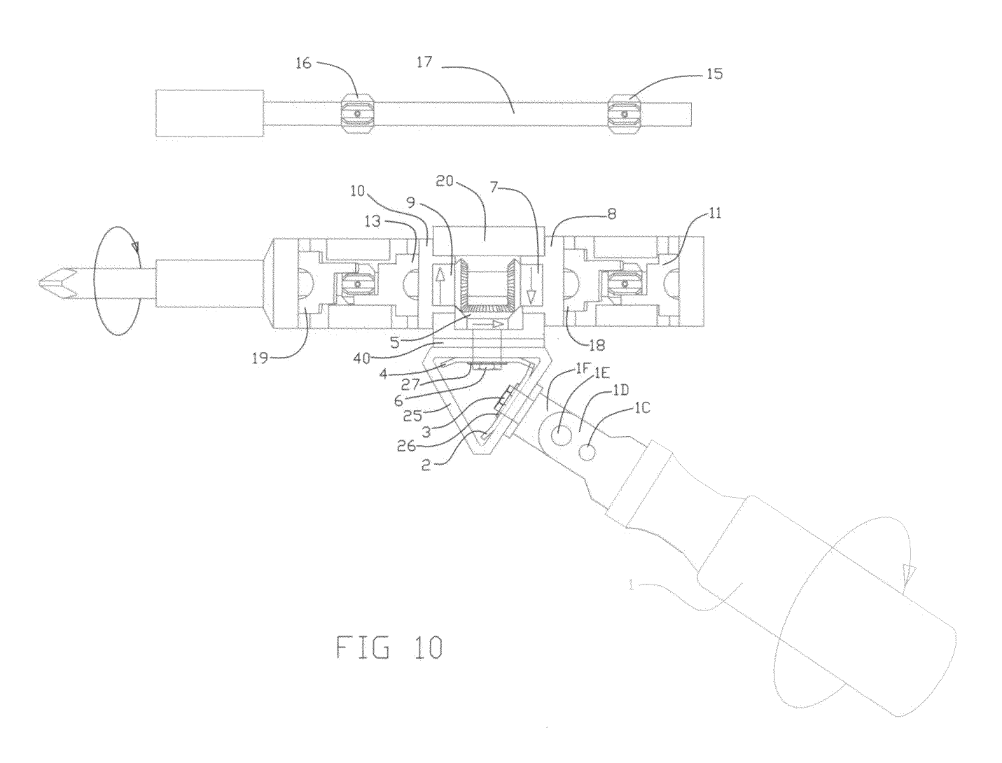

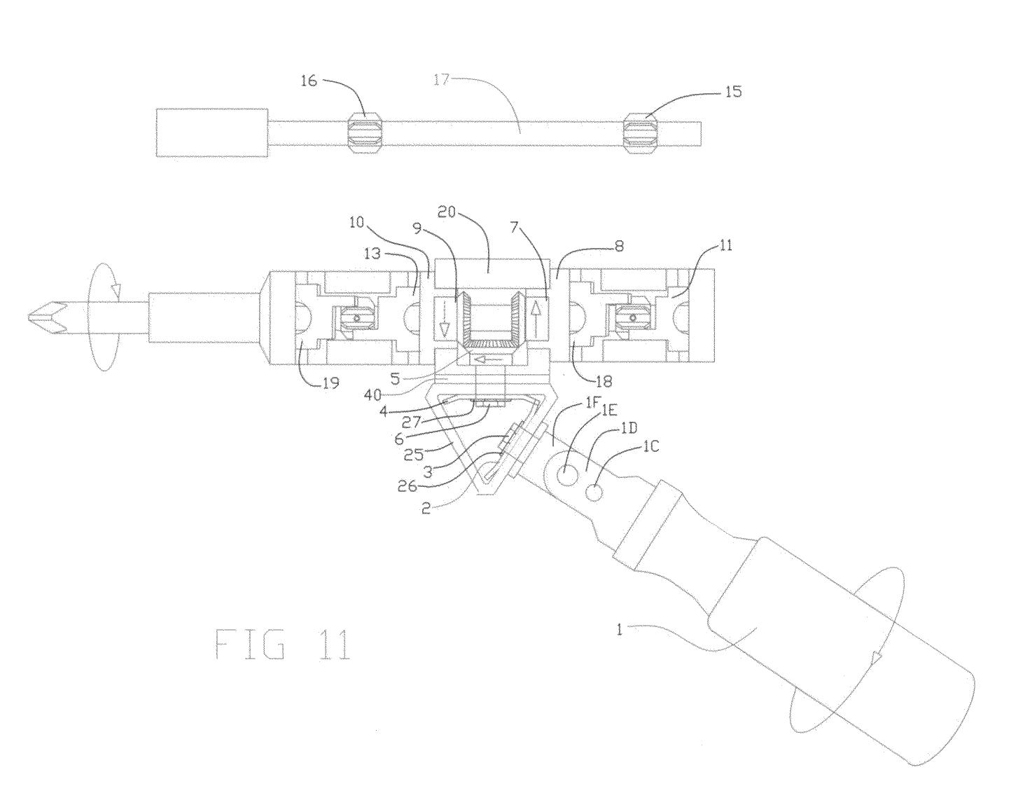

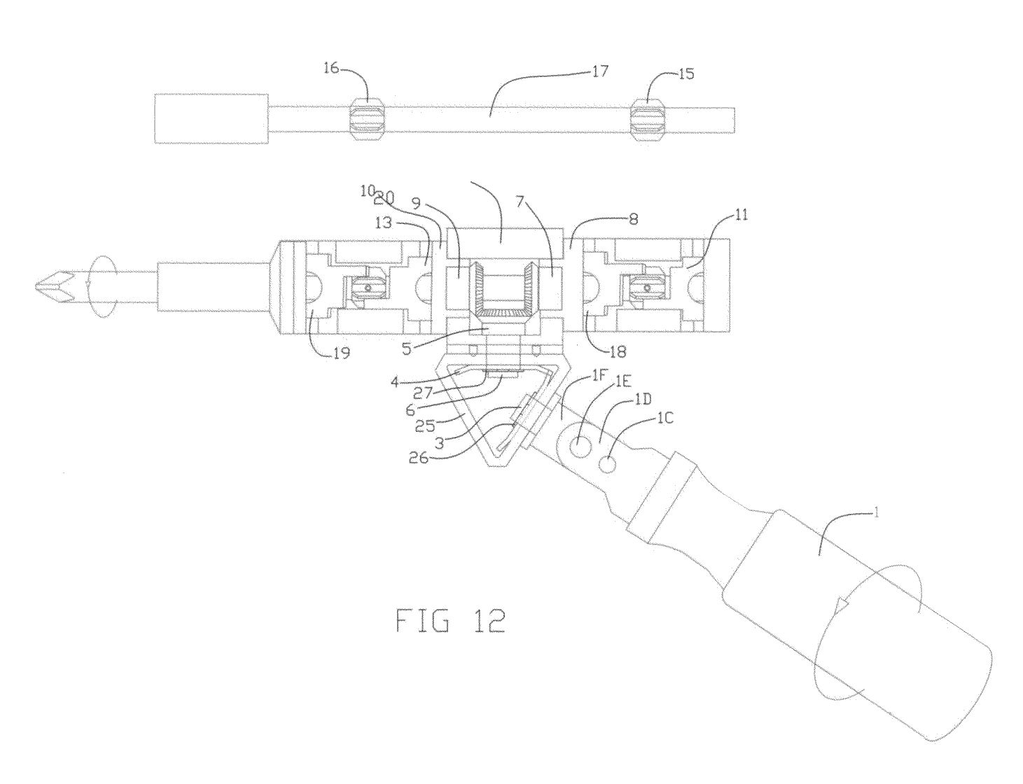

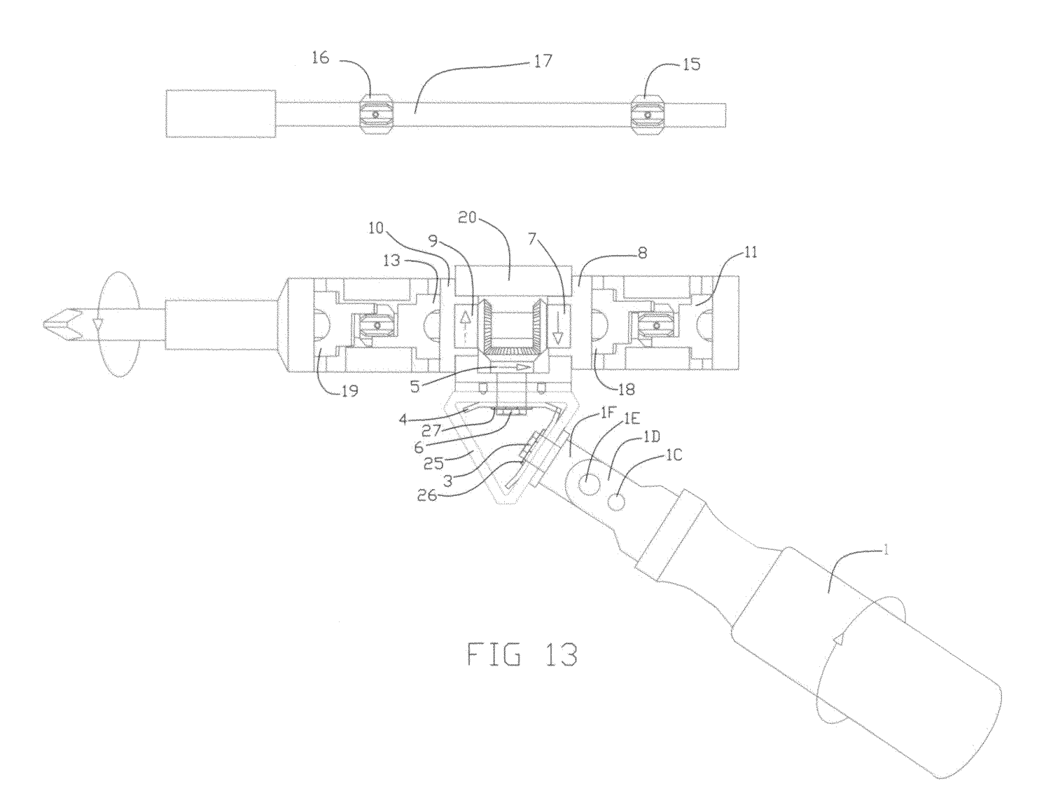

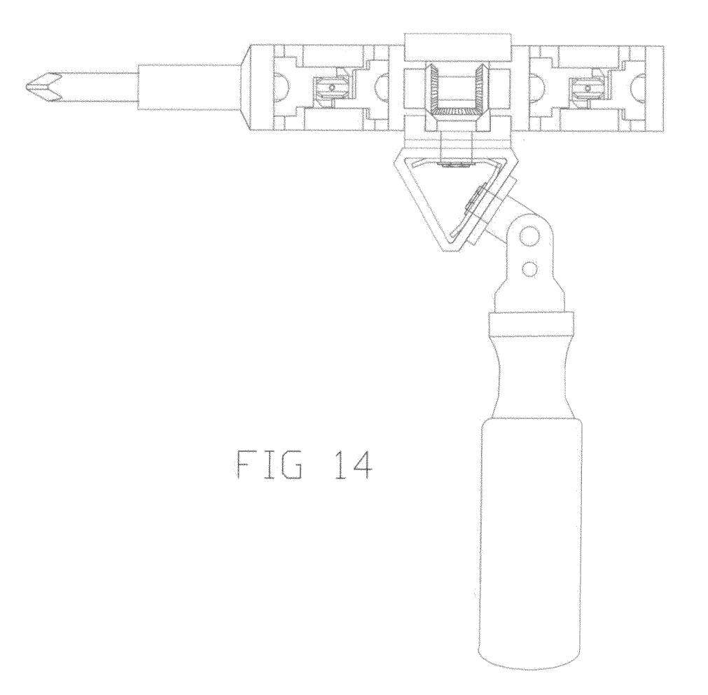

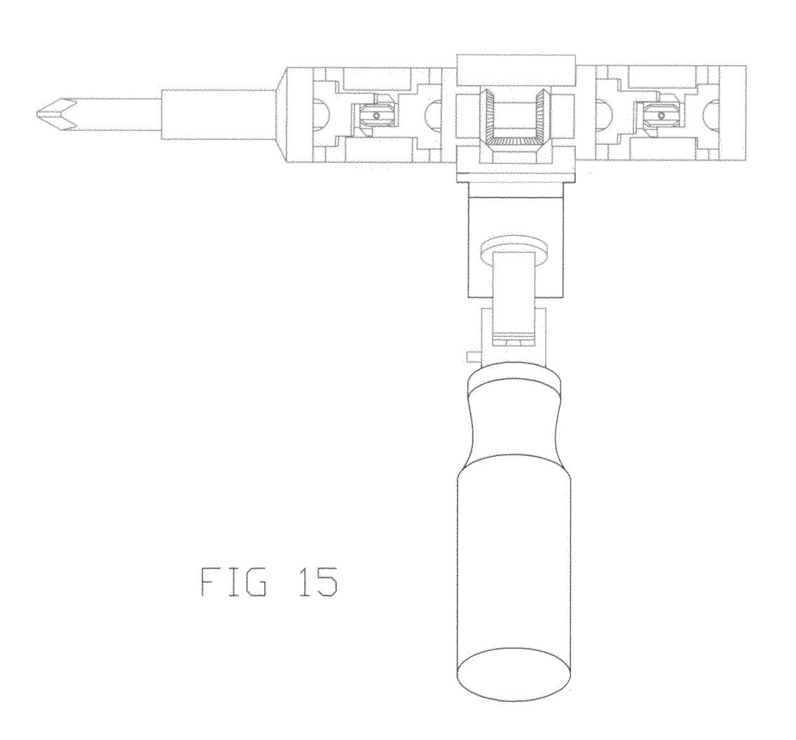

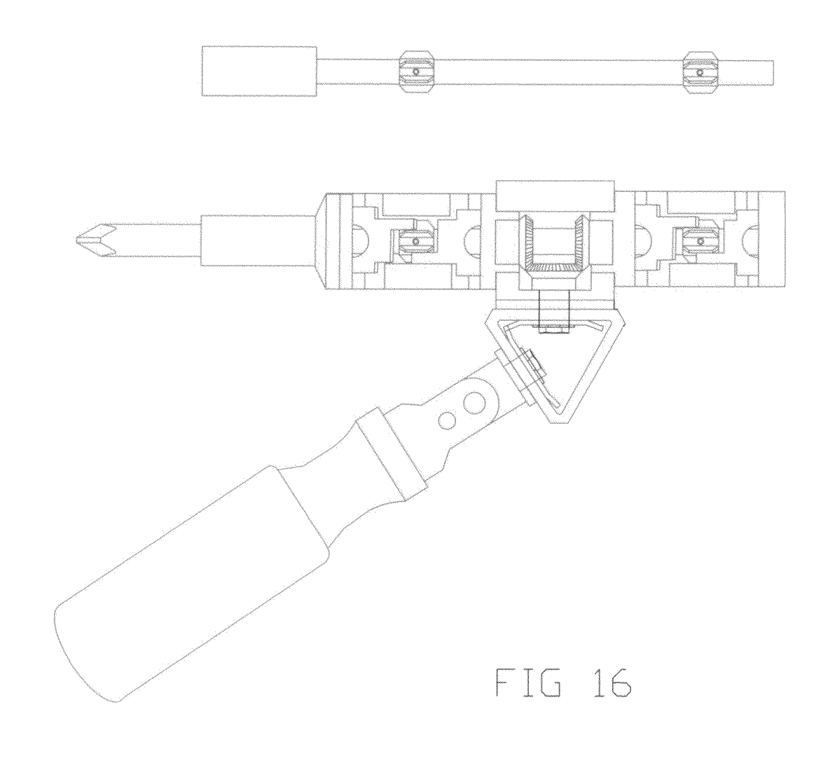

FIG. 5, 10: Pawl 18 and Pawl 11 are placed into their respective recesses in Ratchet Housing 8 with their finger-like extensions engaging the teeth of Toothed Ratchet Wheel Spring-loaded Switch 31, is placed onto Pawls 18 and 11 with its button facing up; Spring-Loaded Switch 31 is compressed against Pawls 18 and 11 while Sleeve 41 is slid onto Ratchet Housing 8 with the button of Spring-Loaded Switch 31 projecting up through slot provided in Sleeve 41.

FIGS. 5A, 5B, 5C, 5D, 5E: Exploded view of components of Adjustable-Angle Handle of screwdriver, Triangular Mounting Bracket 25 and Anti-Rotation Curved-Channel Nest 40.

Hex-shaped socket 1A is pressed into bore provided in Handle 1; Hex-shaped extension 1B, is inserted into hex-shaped socket 1A and retained into socket, with spring-loaded ball 1BB. Pivot Pin 1E, enables 1D to be set to any of several preset angles relative to 1F. Spring-loaded lock 1C, retains any preset positions, that 1D is set to, relative to 1F. Hex-shaped center-opening of gear 2, is placed onto hex-shaped extension 3. Retaining-ring 26 is installed into circular groove provided in 3, to retain gear 2 in place on 3.
Bottom surface of cylindrical Gear Train Housing 20 rests in Anti-Rotation Curved-Channel of Nest 40, to prevent rotation of Gear Train Housing. Spring-Loaded Balls 41 and 42 are installed into bores provided on either side of opening in Gear Train Housing. Spring-Loaded Balls mate with a plurality of detents to retain Handle 1 into a plurality of positions relative to the screwdriver body.

FIG. 5A, FIG. 10: Triangular-Bracket 25 is butted against bottom outside surface of Gear Train Housing 20 with the hexagonal-end of Axle 6 projecting through circular opening in Triangular-Bracket 25. Gear 4, provided with a hexagonal center hole, is placed onto hexagonal end of Axle 6, and butts against surface of Triangular-Bracket 25. Retaining-Ring 27 is installed into groove provided at hexagonal end of Axle 6, to retain Gear 4 in place.

FIG. 5A, FIG. 10: Hexagonal Post 3 is pressed to half its length into bore provided in the flanged-end of Pivoting Mechanism 1C, 1D, 1E, 1F. Gear 2 is placed onto Triangular Bracket 25, so hexagonal center hole of Gear 2 coincides with the hexagonal opening in Triangular-Bracket 25. Free-end of Hexagonal Post 3 is inserted through hexagonal-shaped opening in Triangular-Bracket 25 and Gear 2. Retaining-Ring 2 is installed into groove provided in Post 3 to retain Gear 2 in place.

FIG. 6: Switches 31, 33 and 39 are in forward-most position, to cause CW rotation of Shaft 17.

FIG. 7: Switches 31, 33 and 39, are in back-most position, to cause CCW rotation of Shaft 17.

FIG. 8: Switches 31, 33 and 39 are in middle position, to cause standard direct-drive (non-ratcheting)

FIG. 9: Side view of the Slideable-Linkage of the switches, integrated onto screwdriver body. Switch components 30, 31, 32, 33, 34, 35, 36, 37, 38 and 39 move as a unit.

FIG. 9A: A side-view of the three sections of the Slideable-Linkage, shown aligned and engaged for simultaneous switching. Spring-loaded ball plunger 44, engages with detents in switch 39, to retain all switches in their posterior-most or anterior-most or central positions.

FIG. 9B: A top-view of the three sections of the Slideable-Linkage, shown aligned and engaged for simultaneous switching.

FIG. 9C: The three sections of the Slideable-Linkage are shown out-of-alignment, when rotation is being applied to handle while driving hardware.

FIG. 10: View of the internal configuration and rotation analysis of components with CW rotation applied to the input to produce CW rotation at the output.

FIG. 11: View of the internal configuration and rotation analysis of components with CCW rotation applied to the input to produce CW rotation at the output.

FIG. 12: View of the internal configuration and rotation analysis of components with CCW rotation applied to the input to produce CCW rotation at the output.

FIG. 13: View of the internal configuration and rotation analysis of components, with CW rotation applied to the input to produce CCW rotation at the output.

FIG. 14: The adjustable handle is angled to 90-degrees from the driver body for increased torque capability.

FIG. 15: The handle pivots to 90-degrees to the driver body, for perpendicular driving.

FIG. 16: The handle pivots to 180-degrees to the driver body, for special driving applications.

### DESCRIPTION OF THE PREFERRED EMBODIMENT

The following describes the dynamic cooperation of components of a self-ratcheting mechanism that employs a pair of standard ratchet and pawl arrangement.

FIG. 6: Switches 31, 33 and 39 are set into position, to cause CW output, whereby, posterior leg 30, of switch 31, forces finger of pawl 11 into engagement with tooth wheel 15, while its anterior leg 32, forces finger of pawl 18 to pivot out of engagement from tooth wheel 15. Posterior leg 33 of switch 35, forces finger of pawl 13 into engagement with tooth wheel 16, while its anterior leg 34, forces finger of pawl 19 to pivot out of engagement from tooth wheel 16. CW rotation applied to the input-handle, causes CW output-rotation at the driving end.

FIG. 10: clockwise rotation applied ‘axially’ to handle 1, causes Gear 2 to rotate CW, Gear 4 and axle 6 to rotate CW, Gear 5 to rotate CW, Gear 9 to rotate CW, ratchet Housing 10 to rotate CW, Finger of Pawl 13 to mesh with and impart CW rotation on Tooth Wheel 16, which imparts CW rotation on output Shaft 17.

Simultaneously, Gear 5, while rotating CW, causes Gear 7 to rotate CCW, Ratchet Housing 8 to rotate CCW and Finger of Pawl 11 to override Tooth Wheel 15, thereby ratcheting-up automatically.

FIG. 11: counterclockwise rotation applied ‘axially’, to handle 1, causes Gear 2 to rotate CCW, Gear 4 and axle 6 to rotate CCW, Gear 5 to rotate CCW, Gear 7 to rotate CW, Ratchet Housing 8 to rotate CW, Finger of Pawl 11 to impart CW rotation on Tooth Wheel 15, which imparts CW rotation on output Shaft 17.

Simultaneously, Gear 5, rotating CCW, causes Gear 9 to rotate CCW, Ratchet Housing 10 to rotate CCW, Finger of Pawl 13 to override Tooth Wheel 16, thereby ratcheting-up automatically.

FIG. 7: Switches 31, 33 and 39, are set into position, to cause CCW output, whereby, anterior leg 32 of switch 31, forces finger of pawl 18 into engagement with tooth wheel 15, while its posterior leg 30, forces finger of pawl 11 to pivot out of engagement from tooth wheel 15. Anterior leg 34 of switch 35, forces finger of pawl 19 into engagement with tooth wheel 16, while its posterior leg 33, forces finger of pawl 13 to pivot out of engagement from tooth wheel 16. CW rotation applied to the input-handle, causes CW output-rotation at the driving end. CCW rotation is applied to the input-handle, to cause CCW output-rotation at the driving end.

FIG. 12: counterclockwise rotation applied ‘axially’ to handle 1, causes Gear 2 to rotate CCW, Gear 4 and axle 6 to rotate CCW, Gear 5 to rotate CCW, Gear 9 to rotate CCW, Ratchet Housing 10 to rotate CCW, Finger of Pawl 19 to impart CCW rotation on Tooth Wheel 16, which imparts CCW rotation on output Shaft 17. Simultaneously, Gear 5, rotating CCW, causes Gear 7 to rotate CW, Ratchet Housing 8 to rotate CW, Finger of Pawl 18, to override Tooth Wheel 15, thereby ratcheting-up automatically

FIG. 13: clockwise rotation applied ‘axially’ to handle 1, causes Gear 2 to rotate CW, Gear 4 and axle 6 to rotate CW, Gear 5 to rotate CW, Gear 7 to rotate CCW, Ratchet Housing 8 to rotate CCW, Finger of Pawl 18 to impart CCW rotation on Tooth Wheel 15, which imparts CCW rotation on output Shaft 17, to rotate output CCW.

Simultaneously, Gear 5, rotating CW, causes Gear 9 to rotate CW, Ratchet Housing 10 to rotate CW, Finger of Pawl 19 to override Tooth Wheel 16, thereby ratcheting-up automatically.

FIG. 8: Switches 31, 33 and 39 are set into position, to cause standard direct-drive (non-ratcheting), whereby, anterior leg 32 of switch 31, forces finger of pawl 18 into engagement with tooth wheel 15, while its posterior leg 30 forces finger of pawl 11 into engagement with tooth wheel 15. Anterior leg 34 of switch 35, forces finger of pawl 19 into engagement with tooth wheel 16, while its posterior leg 33, forces finger of pawl 13 into engagement with tooth wheel 16.

FIG. 9: The three sections of the Slideable-Linkage are shown out-of-alignment, when rotation is being applied to handle while driving hardware. Spring-loaded ball plunger 44, mates with detents in switch 39, to retain all switches in their posterior-most or anterior-most or central positions

FIG. 9A: The three sections of the Slideable-Linkage are shown in-alignment for simultaneously moving all three switches to one of three positions.

FIG. 14: With both ratchets in locked position, Pistol-Grip Handle is pivoted down further, to perpendicular to screwdriver body, to provide increased mechanical advantage, for applying final fastening torque.

FIG. 15: Handle is pivoted perpendicular to screwdriver body, to enable driving hardware at a 90-degree angle for motion-limited spaces.

FIG. 16: Handle is shown pivoted 180-degrees and can be pivoted 360-degrees. While the description lists numerous specifics, it must be understood that these specifics are solely for the purpose of exemplification. The self-ratcheting concept employs a minimum of a pair of any ratcheting or clutching means to achieve the self-ratcheting function. Numerous other configurations, consisting of various other mechanical components, can be employed, to achieve the self-ratcheting result.

What is claimed is:

1. A multi-usage, self-ratcheting mechanism, that mechanizes manually-operated consumer, industrial and medical products, to increase their usage efficiency, enhance their ergonomics, provide a mechanical advantage and comprising:
a minimum of two ratcheting/clutching means, operable in forward, reverse and standard modes, for alternately and selectively imparting axial rotation in either direction onto a drive shaft, from an oscillatory input motion,
a socket at one end of said drive shaft, for receiving and driving tool bits and a minimum of two mechanical means, located along the shaft, for alternately engaging with said ratcheting/clutching means, to cause the drive shaft to rotate axially in either direction,
a gear, coaxially fitted to one end of each ratcheting/clutching means, with said gears facing each other, for causing the ratcheting/clutching means to rotate oppositely about the drive shaft in either direction,
a third gear, fixed on an axle and disposed perpendicularly, for meshing simultaneously with said gears that face each other, to cause their opposite rotation,
a hollow cylindrical housing for enclosing said gears,
a tandem arrangement of the ratcheting/clutching means on the drive shaft, with said housing separating the two or more ratcheting/clutching means, to cause their opposite rotation about the drive shaft,
an anti-rotation nest having a centered curved channel to receive said cylindrical housing
a triangular enclosed bracket, having a round opening, centered in two adjacent legs for one side of said bracket being pivotally-retained to said axle and parallel to said housing and a second side for mounting of handle.
a hinged member, coupled to one end of a handle for pivoting and locking said handle into a plurality of predetermined angles, with the face of handle rotatably retained against the outside surface of angled second leg of said two-legged angled-bracket, for bidirectional axial rotation and radial swing of said handle,
a plurality of detents in the posterior end of said hinged member, for receiving a spring-loaded ball, to lock handle into a plurality of angles,
a sliding pin in the hinged member, for locking said spring-loaded ball into any one of said detents,
a fourth gear, fixed onto the opposite end of the axle and facing away from the third toothed member at opposite end of the axle,
a fifth gear, fixed onto a post projecting from the handle and meshing with the fourth toothed member
